(19) United States
(12) Patent Application Publication
(10) Pub. No.: US 2007/0132550 A1
(43) Pub. Date: Jun. 14, 2007

(54) Electromechanical Lock Device And Method

(75) Inventors: Meir Avraham, Rishon Lezion (IL); Itzhak Pomerantz, Kefar Saba (IL); Nitzan Achsaf, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: MSYSTEMS LTD., Kfar Saba (IL)

(21) Appl. No.: 11/567,221

(22) Filed: Dec. 6, 2006

Related U.S. Application Data
(60) Provisional application No. 60/748,295, filed on Dec. 8, 2005.

(51) Int. Cl. G05B 19/00

(52) U.S. Cl. 340/5.21; 340/5.61; 70/277

(57) ABSTRACT

An electromechanical lock device includes a communication mechanism, wherein are received digital data include an instruction set of operational instructions; a controller that is operative to produce electric signals in association with the instruction set; an actuator that is responsive to the controller to perform a set of operations that correspond to the electronic signals; and a lock mechanism that is manipulated in response to the set of operations, such that the locking mechanism is operative to unlock according to a specific pre-defined set of operations. A token operationally interacts with the communication mechanism of the electromechanical lock device. Access to a location is controlled by blocking the access using such an electromechanical lock device.

### CROSS-REFERENCE TO RELATED APPLICATIONS

This patent application claims the benefit of U.S. Provisional Patent Application No. 60/748,295, filed Dec. 8, 2005.

### FIELD OF THE INVENTION

The present invention relates to the field of electromechanical locks.

### BACKGROUND OF THE INVENTION

Combination locks are well known in the art. They are opened by manually rotating a dial that sequentially aligns a set of movable members to a position that enables the lock to open.

Prior art combination locks have two inherent disadvantages. Firstly, prior art combination locks cannot be operated automatically and requires a manual movement of dials. Secondly, there is no way to selectively deny from a user that knows the matching dial combination to open the combination lock, without physically altering the combination lock.

Electromechanical combination locks, including a recognizer unit and an actuator unit, are also well known in the art. The term “actuator” in this application refers to any lock that converts electric energy to a functional mechanical motion. An electric motor is a special case of an actuator. A user opens an electromechanical lock by entering a password or showing a token or a biometric signal. After the authority of the user is verified by the recognizer unit of the lock, an internal signal is sent from the recognizer unit to the actuator unit of the lock, instructing the electromechanical lock to open.

The main disadvantages of prior art electromechanical locks are—
a. If one breaks his way into the internal communication line between the recognizer unit to the actuator unit, he/she can instruct the actuator unit to open by-passing the recognizer unit.
b. As electromechanical locks known in the art are designed to prevent easy by-passing of the recognizer unit, an electronic failure alert mechanism of the recognizer unit makes it very hard for an authorized user to manually open the lock (in emergency cases for example).

It would be thus desirable to provide a different electromechanical lock, designed to overcome these disadvantages of prior art devices.

### SUMMARY OF THE INVENTION

The essence of this invention is a general purpose electromechanical lock that offers a unique combination of convenience and reliability that does not exist in the prior art.

The convenience is found in the ability of the user to open the lock by presenting a token, and the ability of the owner to remotely add and remove access rights.

The reliability is found in the ability to open the lock securely and repeatedly when its digital processor, its storage and even all its electronic components go out of order.

This invention is achieved by using a locking mechanism that responds to a set of manipulation instructions, where the instructions can be inputted to the mechanism electronically and mechanically, locally and remotely.

The lock has a mechanical part that physically locks and unlocks as an ordinary dial-lock when a set of mechanical members inside the lock are aligned. Typically, the members can each move between a large number of positions, and the lock is unlocked only if each of the members is in a pre-defined position. The number of possible states of the lock is the number of positions of each member, to the power of the number of members in the lock—typically a very large number.

Some lock mechanisms are designed so that the time to position all the members in a new position is large—several seconds—a small penalty for the legitimate user, but a prohibitive deterrent for the blind guessing hacker.

The lock of the present invention has an electrical manipulator—such as an electric motor, that can manipulate the members precisely per electronic instructions. The instructions can come either from inside the lock or from outside the lock.

When the user knows the right combination, he has means to communicate the combination, as a set of instructions, into the lock. The actuator will obey the instructions and the lock will open quickly.

When the user does not know the right combination, and is not supposed to know the right combination—the instructions can be stored on a token, encrypted so that the lock can decrypt them using a secret key embedded in the lock, and the lock can input the encrypted instructions, decrypt them and follow them to open.

When the user is not supposed to know the instructions, and his access to the lock has to be revocable by the owner at any time—he is given a token that does not carry any information except for its own ID number. The lock stores, in a secure local memory, the instruction set. When the lock sees a token, it searches a locally stored list of authorized tokens, and if it finds the guest token in the list, it sends the instructions from its own memory to the actuator, and the lock opens.

If the owner wants to prevent one token user from copying the encrypted instruction set from another token user (“duplicating a key”), the lock can use a hash mechanism to avoid opening with a copied key: Upon loading the encrypted key to the token, the owner hashes the instructions set with the ID number of the token. The result hash file does not reveal the secret instruction set. The hash file is stored on the token with the encrypted instructions set. When the token is presented to the lock, the lock reads the encrypted instruction set, the hash file and the token ID number. If the encrypted file decrypts successfully, the lock hashes the decrypted instruction set with the ID number, the resulting hash file must be identical to the hash file read from the token. If it is not—then the lock knows that the key is a copy from another token, and does not open.

If the owner wishes to revoke the right of entry from one of the token holders, he can erase that ID number from the list, and this token will not open the lock any more. If the owner adds a token to the list—the token will be able to open the lock.

If the electronic part of the lock fails—due to power fail or to a malfunctioning component or due to hacking of the software—a user who knows the set of instructions can activate the mechanism manually, using a dial or a screw driver—and manipulate each member to its pre defined position and open the lock.

Accordingly, it is a principal object of the present invention to disclose an alternative method to prior art techniques for lock devices by providing a combination lock that is operative to activate a motor to unlock the combination lock in response to a predetermined sequence of operational instructions (referred herein to a dial combination) typically received from a user.

A pre-defined sequence of operational instructions refers herein to any information including at least two operations (e.g. mechanical operations or electrical operations) associated only with how the electromechanical lock device works to unlock and do not particularly identify the user or any action/process made by the user. Each operational instruction is converted to an operation that is to be sequentially performed by the electromechanical lock device to unlock the electromechanical lock device.

The essence of the invention is a combination lock that can manipulated both manually—using dials or a screwdriver, and electromechanically—using a motor that performs a respective sequence of mechanical operations, in response to the pre-determined sequence of logical instructions electrically received from a user, to unlock the combination lock.

In accordance with one embodiment, the dial combination is stored in a portable storage device that is carried by a user. The actuator is provided to turn the dial in accordance with this dial combination received from the portable storage device.

In accordance with another embodiment, a ‘recognizer unit’ authenticates the user and an actuator turns a dial to unlock the lock in accordance with a dial combination stored in a local memory of the lock.

In accordance with yet another embodiment, the dial combination stored in the portable storage device is encrypted, so that an unauthorized user having access to the portable storage device does not know the dial combination that is pre-defined to open the lock.

In accordance with another embodiment, a user can manually manipulate the dial and unlock the lock.

In accordance with another embodiment, the dial combination stored in the portable storage device is hashed with an ID number of the portable storage device, so that the lock can verify that the encrypted combination of the lock is not copied from another portable storage device. This verification procedure applied by the lock is achieved by hashing the decrypted combination with the ID number of the portable storage device and comparing the result to the hashed information stored in the portable storage device.

In accordance with another embodiment, the electromechanical lock device of the present invention is configured to unlock in accordance with a pre-determined set of operational instructions, where the pre-determined set of operational instructions are entirely electromagnetic voltage levels.

In accordance with the present invention, there is provided an electromechanical lock device that includes: (a) communication mechanism that is operative to receive digital data that include an instruction set of least one operational instruction; (b) a controller that is operative to produce electronic signals in association with the instruction set; (c) an actuator that is responsive to the controller to perform a set of operations that correspond to the electronic signals; and (d) a locking mechanism that is manipulated in response to the set of operations, such that the locking mechanism is operative to unlock according to a pre-defined set of operations.

Preferably, the actuator includes a motor.

Preferably, the digital data are encrypted. More preferably, the electromechanical lock device also includes a decrypting mechanism for decrypting the encrypted digital data. Most preferably, the electromechanical lock device also includes a hashing mechanism for hashing the decrypted digital data.

Preferably, the electromechanical lock device also includes an authentication mechanism for authenticating the digital data that are communicated to the electromechanical lock. More preferably, the electromechanical lock device also includes a memory, wherein a pre-defined instruction set of at least one operational instruction, respective to the pre-defined set of operations, is stored locally. Also more preferably, the lock mechanism is operative to unlock conditional on a value of at least one parameter, such as current time a user operates the lock mechanism, number of recent entries of the user, number of attempts made by the user to open the lock mechanism, content of the digital data, identity of a token carrying the digital data, etc.

Preferably, the lock mechanism includes at least two movable parts that are reversibly electromechanically manipulated to predefined mechanical positions to unlock the lock mechanism.

Preferably, the communication mechanism includes a mechanism, such as an electronic sensor, an optical sensor, an acoustic sensor, a magnetic sensor, and a keypad.

Preferably, the electromechanical lock device also includes a token that operationally interacts with the communication mechanism to unlock the lock mechanism. More preferably, the said token includes a non-volatile memory, wherein an instruction set of at least one operational instruction pre-defined to unlock the lock mechanism is stored. Also more preferably, the token is a portable carrier of information, such as an electronic card, a smart card, a magnetic card, a key pad, and a USB flash memory data storage device. Also more preferably, the token includes a biometric sensor for reading a biological feature of a user.

Preferably, the token operationally interacts with the communication mechanism via a wired communication link. Alternatively, the token operationally interacts with the communication mechanism via a wireless communication link.

Preferably, the electromechanical lock device also includes a manual entry mechanism that is operative to unlock the electromechanical lock device in response to manually manipulating the electromechanical lock device according to the pre-defined set of operations. More preferably, the manual entry mechanism includes a dial that is manually manipulated by a user to unlock the lock mechanism. Also more preferably, the manual entry mechanism includes a keypad.

Preferably, the controller is also operative to inform a remote device when an attempt is made to operate the electromechanical lock device.

Preferably, the instruction set of at least one operational instruction includes voltage levels of electromagnets. More preferably, the lock mechanism includes at least two electromagnetic cores that are reversibly electromagnetically manipulated to predefined mechanical positions to unlock the lock mechanism.

In accordance with the present invention, there is further provided an electromechanical lock system that includes a plurality of the electromechanical lock devices described herein, where each electromechanical lock device operationally interacts with at least one respective token.

In accordance with the present invention, there is further provided a method of controlling access to a location that includes the steps of: (a) receiving digital data that include an instruction set of at least one operational instruction; and (b) blocking access to the location using an electromechanical lock device that is operative to unlock in accordance with a pre-defined instruction set of at least one operational instruction.

Preferably, the opening of the electromechanical lock device is effected in response to electromechanically manipulating at least two movable parts to pre-defined mechanical positions.

Preferably, the method also includes the step of providing at least one user with a token, storing the pre-defined instruction set of at least one operational instruction, of which interacts with the electromechanical lock device to enable access to the location. More preferably, the method also includes the step of sending, via the token, the pre-defined instruction set of operational instructions to the electromechanical lock device as encrypted digital data. Also more preferably, the method also includes the step of sending, via the token, the pre-defined instruction set of operational instructions to the electromechanical lock device as digital data hashed in association with a respective identification parameter of the token.

Preferably, the token is a portable carrier of information, such as an electronic card, a smart card, a magnetic card, a key pad, and a USB Flash memory storage device.

Preferably, the interaction of the token with the electromechanical lock device is effected via wired communication. Alternatively, the interaction of the token with the electromechanical lock device is effected via wireless communication.

Preferably, the method also includes the steps of; storing the pre-defined instruction set of operational instructions locally in the electromechanical lock device; and authenticating the digital data, such that the electromechanical lock device is operative to unlock contingent on authentication of the digital data and according to the pre-defined instruction set of operational instructions that are locally stored in the electromechanical lock device. More preferably, access to the location is conditional on a value of at least one parameter, such as current time the user operates the lock mechanism, number of recent entries of the user, number of attempts made by the user to open the lock mechanism, content of the digital data, identity of the token, etc.

Preferably, the method also includes the step of manually manipulating the electromechanical lock device, according to the pre-defined instruction set of operational instructions, to enable access to the location.

Preferably, the method also includes the step of informing a remote device when an attempt is made to operate the electromechanical lock device.

Preferably, the pre-defined instruction set of operational instructions include voltage levels of electromagnets. More preferably, the opening of the electromechanical lock device is effected by electromechanically manipulating at least two electromagnetic cores to pre-defined mechanical positions.

Preferably, the lock mechanism is operative to unlock conditional on recognition of a token that is included in an internal list of authorized tokens.

Preferably, the lock mechanism is operative to unlock contingent on receiving a pre-defined instruction set of operational instructions.

Preferably, the lock mechanism is operative to unlock contingent on receiving an encrypted file that successfully decrypts, using a secret key embedded in the electromechanical lock device, into the instruction set of operational instructions. More preferably, the electromechanical lock device also includes a mechanism for hashing the decrypted instruction set in association with an identification of a token carrying the encrypted file, such that the lock mechanism is operative to unlock if the hashed instruction set is identical to hashed data that are pre-loaded on the token.

Preferably, the communication mechanism includes an input device.

Preferably, the lock mechanism is operative to unlock according to all-mechanical input.

Preferably, the receiving of the digital data is effected using an input device.

Preferably, the receiving of the digital data is effected using a token. More preferably, the method also includes the step of encrypting the instruction set on the token. Also more preferably, the method also includes the step of storing, on the token, a hashed instruction set that is hashed in associated with an identification parameter of the token. Most preferably, the method also includes the steps of encrypting the instruction set with a secret key of the electromechanical lock device; decrypting the encrypted instruction set; hashing the decrypted instruction set in association with the identification parameter of the token; and conditional on verification of the decrypted instruction set and only if the hashed instruction set is identical to the hashed instruction set stored on the token, unlocking the electromechanical lock device.

Preferably, the method also includes the step of comparing an identification parameter of the token to a list of authorized values stored in the electromechanical lock device. More preferably, the method also includes the step of remotely editing this list.

In accordance with the present invention, there is further provided an electromechanical lock device that includes a lock mechanism that is operative to unlock in response to a pre-defined instruction set of at least one operational instruction remotely communicated to the electromechanical lock device as digital data.

As can be seen, the electromechanical lock device of the present invention deals with all the disadvantages of prior art lock devices, in the following way:

| Problem | Preliminary measures | How is the problem solved |
|---|---|---|
| Need to be able to | Give such users a token with | Erasing an ID from the list |
| revoke certain users | an ID number, and load the | will prevent the holder of that |
| while not disturbing | electromechanical lock with a | specific ID from unlocking |
| others | list of all authorized ID | the electromechanical. |
| | numbers | |
| The electromechanical | Send the correct motion | The motor will quickly rotate |
| lock cannot open | instructions to an electric | the dial through the sequence |
| automatically | actuator | of logical instructions locally |
| | | stored in the |
| | | electromechanical lock, and |
| | | will unlock the |
| | | electromechanical lock |
| Hacker can bypass the | There is no command to an | The hacker, having gained |
| recognizer unit by | actuator unit to open the lock | access to the control wire, |
| accessing the link to | and the actuator or motor are | does not know how to instruct |
| the internal actuator | only responsive to specific | the motor/actuator to move. |
| | motion instructions. Accessing | |
| | the link would not enable | |
| | opening the lock | |
| There is no way to | Provide manual access that | The user can manually rotate |
| open the | operates independently on | a dial according to the pre- |
| electromechanical lock | electricity | defined sequence of logical |
| if the recognizer unit | | instructions |
| breaks or is hacked | | |

It should be noted that the present invention offers four different levels of access to the electromechanical lock device, each level slower but more secure than the other:
1. Identify the user and activate the actuator according to a dial combination locally stored in the electromechanical lock device.
2. Read a file from the user, decrypt this file and apply the result to the electromechanical lock device (no local storage of secret information).
3. Let the user type the dial combination on a keypad (key cannot be stolen).
4. Let the user rotate the dial manually (Lock cannot be out of order).

In this application, the term “agent” is meant the physical carrier of electronic data that is used for opening a lock—typically a human person who remembers the data or a physical token that stores the data.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding sections or elements throughout, and in which:

FIG. 1 shows a preferred embodiment of the electromechanical lock device of the present invention;

FIG. 2 is a block diagram of the controller of FIG. 1;

FIG. 3 is a block diagram of a preferred embodiment of a token associated with the electromechanical lock device of the present invention;

FIG. 4A is a schematic illustration of an electromechanical lock device including electromagnetic bars, in accordance with another embodiment of the present invention; and

FIG. 4B is a schematic illustration of the electromechanical lock device of FIG. 4A, where all three electromagnets are set on the exact voltage levels pre-defined to open the electromechanical lock device.

### DETAILED DESCRIPTION OF THE PREFERRED EMBODIMENTS

The present invention is an electromechanical lock device and method configured as a combination lock to activate an actuator to open the electromechanical lock device according to a pre-determined set of operational instructions (referred to herein as a dial combination) received from a user. The method of the present invention is a method of controlling access to a location, where a location is defined herein as a physical interior area, such as the interior of a safe, which is protected by the electromechanical lock device.

A pre-defined set of operational instructions refers herein to any information including at least two operations (e.g. mechanical operations or electrical operations) associated only with how the electromechanical lock device works to unlock and do not particularly identify the user or any action/process made by the user. Each operational instruction is converted to an operation that is to be performed by the electromechanical lock device to unlock the electromechanical lock device.

Note that for aspects, such as security, convenience, cost of production and simplicity, the set of operational instructions are optionally converted to sequential operations to-be performed by the actuator of the electromechanical lock device.

Configuring a controller within the electromechanical lock device to activate the motor to open the lock in response to a “verifier” part that determines the validity of a password received from a user, as in the prior art, is provided by the present invention as optional. The controller receives identifying information from the user in order to verify that this user is granted an entry right to open the electromechanical lock device. Only after the user is granted an entry right to open the electromechanical lock device is the dial combination stored in the controller of the electromechanical lock device translated to electromechanical commands that manipulate the motor to open the electromechanical lock device.

The identifying information is stored within any kind of token. The token is any reliable carrier of information that is made available to the user, such as a USB Flash Drive (UFD), which is a NAND-type flash memory data storage device integrated with a USB interface, available from msystems Ltd., Kefar Saba Israel. The token may further be an electronic card, a smart card, a magnetic card, a key pad, and any other portable data storage device. Means for reading the token can be, for example, electronic, optical, acoustic or magnetic.

The identifying information is sent to the electromechanical lock device via a wired communication link. Alternatively, the identifying information is sent to the electromechanical lock device via a wireless communication link.

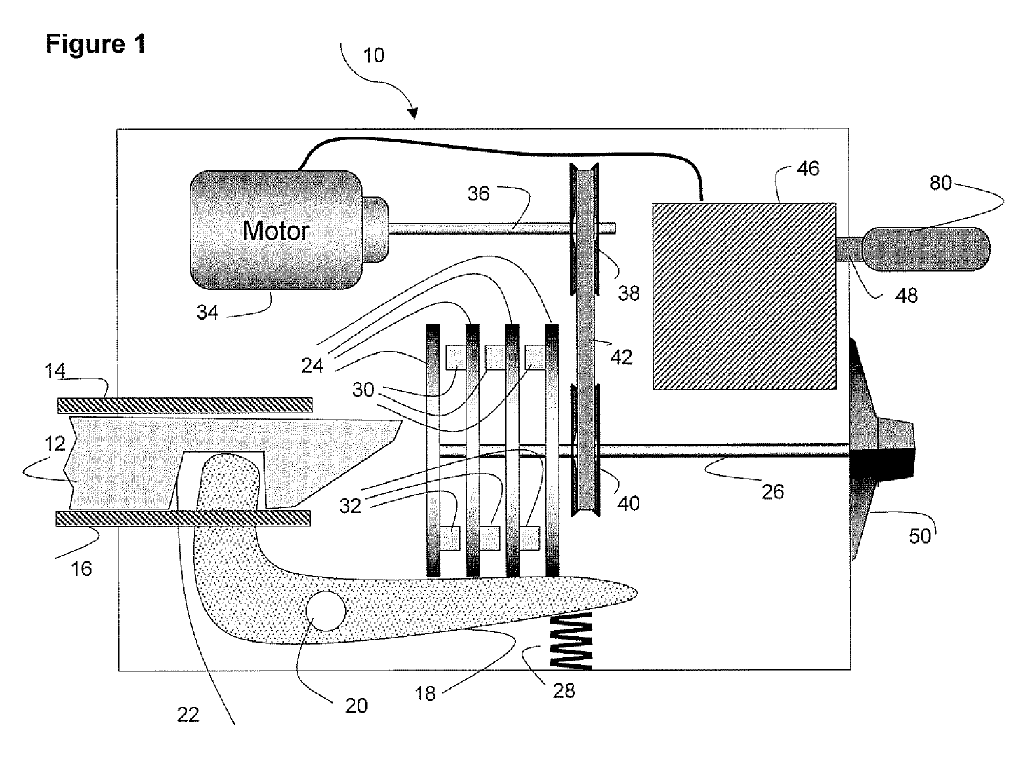

The electromechanical lock device of the present invention is optionally configured to function as a standard combination lock, such that the drive train (elements 26 and 40 of FIG. 1) is manually activated in response to mechanical manipulations made by the user (e.g. dialing the dial combination, rotating a dial back and forth at precise angles, etc.).

Referring to FIG. 1, there is shown the electromechanical lock device 10 of the present invention. The electromechanical lock device 10 includes an actuator 34, such as a stepping motor or a pulsed piezoelectric motor, available from Nanomotion Ltd., Yokneam Israel, which is sequentially manipulated to perform respective mechanical operations in response to a set of operational instructions received from a user. Note that the electromechanical lock device 10 is configured to unlock only when the actuator 34 performs a pre-defined set of mechanical operations that are responsive to the dial combination received from the user.

Electromechanical lock device 10 also includes a drive train (elements 26 and 40 as described below) that is configured to open the electromechanical lock device when driven either manually (as manipulated by a user via dial 50) or electromechanically (by motor 34). The dial combination is received as input to the electromechanical lock device 10 from a token 80 via a communication mechanism 48. Communication mechanism 48 can be optionally implemented as a USB port, a keypad, an electronic sensor mechanism, an optical sensor mechanism, etc. Implementing a biometric sensor, such as a fingerprint reader, within the token for authenticating the user is optional.

In response to the dial combination received from the user, motor 34 is sequentially manipulated to rotate an axle 36. The rotation of axle 36 is transmitted to a wheel 40 by a wheel 38 and a belt 42. The rotation of wheel 40 rotates an axle 26 to any desired position.

The rotation of axle 26 effects the movement of four wheels 24, which are assembled on common axle 26, to individually and relatively freely rotate on common axle 26. The four wheels 24 include respective upper teeth 30 and lower teeth 32 on each side. These upper teeth 30 and lower teeth 32 engage as the four wheels 24 rotate, such that a latch 18 is rotated around its fixed pivot 20.

The rotation of all four wheels 24 enable indentations positioned on each wheel's perimeter (not shown) to properly align, so the latch 18 can rotate. A spring 28 pushes the latch 18 out of a bay 22, thus releasing a hasp 12 that is constrained between two bars 14 and 16 from its locking state and unlocking the electromechanical lock device 10.

Elements 50, 26, 24, 30 and 32 are brought here only as an example to show a conventional mechanical combination lock mechanism. The scope of the invention includes the use of any suitable mechanical combination lock mechanism.

A controller 46 embedded within the electromechanical lock device 10 is operative to manipulate motor 34 in response to the dial combination received from the user.

Also pre-programming the dial combination within controller 46 is provided by the present invention as optional. In such a case, controller 46 receives the identifying information from the user in order to verify that this user is granted an entry right to open the electromechanical lock device 10. Only after the user is granted an entry right to open the electromechanical lock device 10 is the dial combination stored in the controller 46 of the electromechanical lock device 10 translated to electromechanical commands that sequentially manipulate the motor 34 to open the electromechanical lock device 10.

A dial 50 is provided by the present invention as optional. In response to a user manually manipulating dial 50, dial 50 operates directly to rotate the drive train (elements 26 and 40) and open the electromechanical lock device 10. The user manually rotates the dial back and forth at precise angles with respect to the dial combination that is pre-defined to open the electromechanical lock device 10. This rotation procedure causes the indentations of the wheels to become aligned with the latch 18, thus releasing the hasp 12 in order to unlock the electromechanical lock device 10.

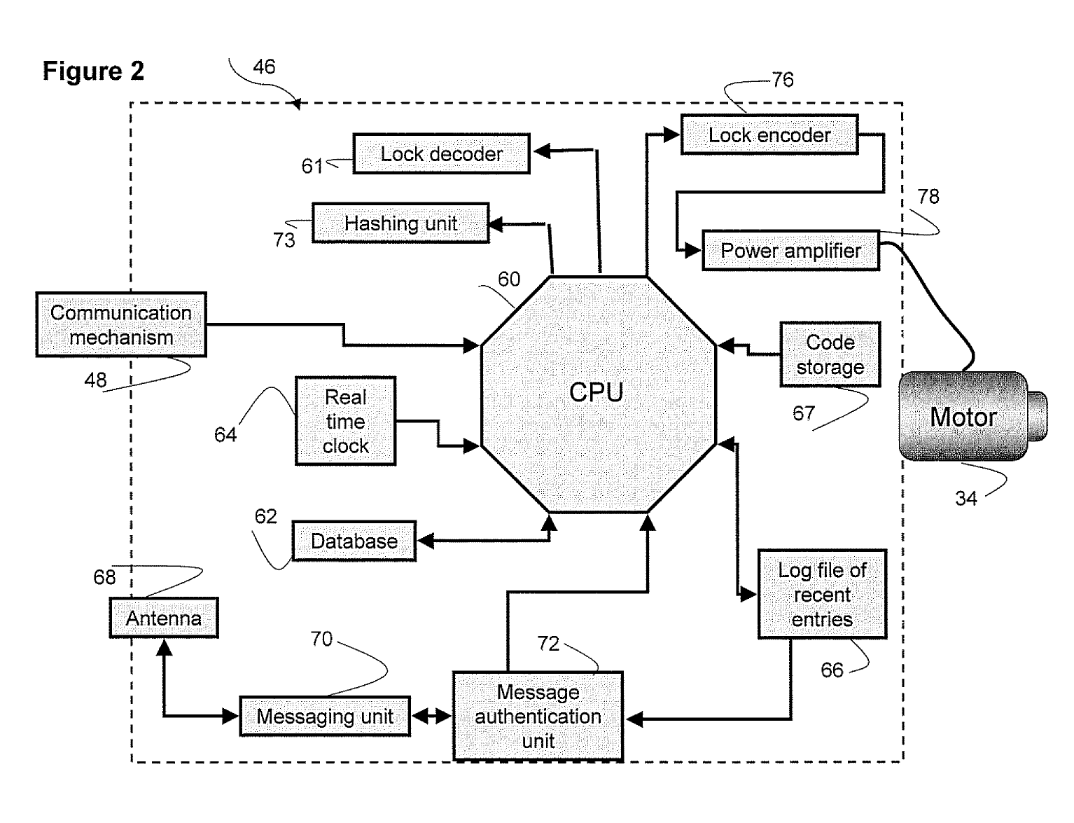

Referring now to FIG. 2, there is shown a block diagram of the controller 46 of FIG. 1. The controller 46 includes a processor (e.g. CPU) 60 that is programmed to activate the motor 36 and open the electromechanical lock device according to specific parameters that are made available to the processor.

Processor 60 receives a dial combination from a user via a communication mechanism 48 and sends the dial combination to be translated via lock encoder 76 to mechanical commands that sequentially electromechanically manipulate motor 34 to open the electromechanical lock device using a power amplifier 78. Communication mechanism 48 can be implemented to be an electronic sensor, an optical sensor, an acoustic sensor, a magnetic sensor, a keypad, or any other means for receiving a dial combination from a remote source.

Motor 34 is electromechanically manipulated in response to sequential set of angular positions, in case motor 34 is a servo motor that can reach a specific angular destination for example, or to a sequential set of incremental motion pulses, in case motor 34 is a step motor or a piezo electric actuator.

Power amplifier 78 is a source of electric power of any form, such as a local battery, an external power source, etc., that matches with the specifications of motor 34.

Optionally, the processor 60 receives a command from the user via communication mechanism 48 signaling electromechanical lock device 10 to activate motor 34 to open the lock in response to user's identifying information (such as a password) received from the user. The user's identifying information is verified against data stored in a database 62 in order to determine whether the user is granted an entry right to open the electromechanical lock device 10. In case the user is granted such an entry right, the dial combination pre-programmed in code storage 67 is translated by lock encoder 76 to electromechanical commands that sequentially manipulate the motor 34 to open the electromechanical lock device 10.

In one embodiment of the present invention, the identifying information is received via a wireless communication link. In such a case, communication mechanism 48 is a wireless receiver. Alternatively, the identifying information is received via a wired communication link, for example by plugging a token (such as an electronic card) containing the identifying information of the user into a USB port. In such a case, communication mechanism 48 is a USB port.

The entry rights are granted to the user upon verification without further limitations. Alternatively, the entry rights are further conditional on parameters that are made available to the processor. One possible parameter is the time of day. The processor 60 uses a real time clock 64 to know the date and the time, such that granting the entry right is conditional on certain hours of day, or certain days of the week.

Another useful parameter is the history of entries. The processor manages a log file 66 of recent entries. Granting the user an entry right is conditional on the fact that the user's identifying information are not available in the log file (i.e., this user has never entered this lock) and the user is granted a one-time entry. Alternatively, granting the user entry rights is conditional on the fact that another user has recently opened the lock (i.e. at least two people are entering together), and so on.

Including a biometric sensor, such as a fingerprint reader, in communication mechanism 48, for verifying the identity of the user, is provided by the present invention as optional.

A Lock Decoder 61 is optionally provided for decrypting encrypted information received from a user and retrieving the dial combination for unlocking the electromechanical lock device 10.

Database 62 is dynamically updated via a wired communication link (e.g. communication mechanism 48, in the embodiment in which communication mechanism 48 is a wired link). Alternatively, database 62 is updated via an antenna 68 that provides a wireless communication with remote base stations that are authorized to update database 62.

Messages received via antenna 68 are stored in a messaging unit 70. These messages carry, for example, updated identifying information for granting new users entry rights, for deleting users from the database 62, for modifying the conditions of entry (limit their entry rights or removing a limitation), etc.

Messages stored in the messaging unit 70 are sent to an authentication unit 72 that authenticates the updated identifying information carried within these messages using conventional digital authentication methods known in the art.

Messaging unit 70 is further operative to store information received from the log file 66 of recent entries. Such authenticated information is of high importance in investigations and in routine security monitoring (e.g. detection of specific users unlocking or attempting to unlock the electromechanical lock device).

A Hashing unit 73 is further optionally provided for enhanced security, in case the dial combination is received to the electromechanical lock device 10 after having been encrypted with a public key and also hashed with the key ID. Electromechanical lock device 10 then decrypts the encrypted dial combination (via Lock Decoder 61) using its private key and then hashes (via Hashing unit 73) the decrypted data using the Key ID) received from the token. In such case, controller 46 may be implemented to condition the entry right given to the user upon determining a match between the hashing of the decrypted data (via Hashing unit 73) and the hashed dial combination that is received from the token.

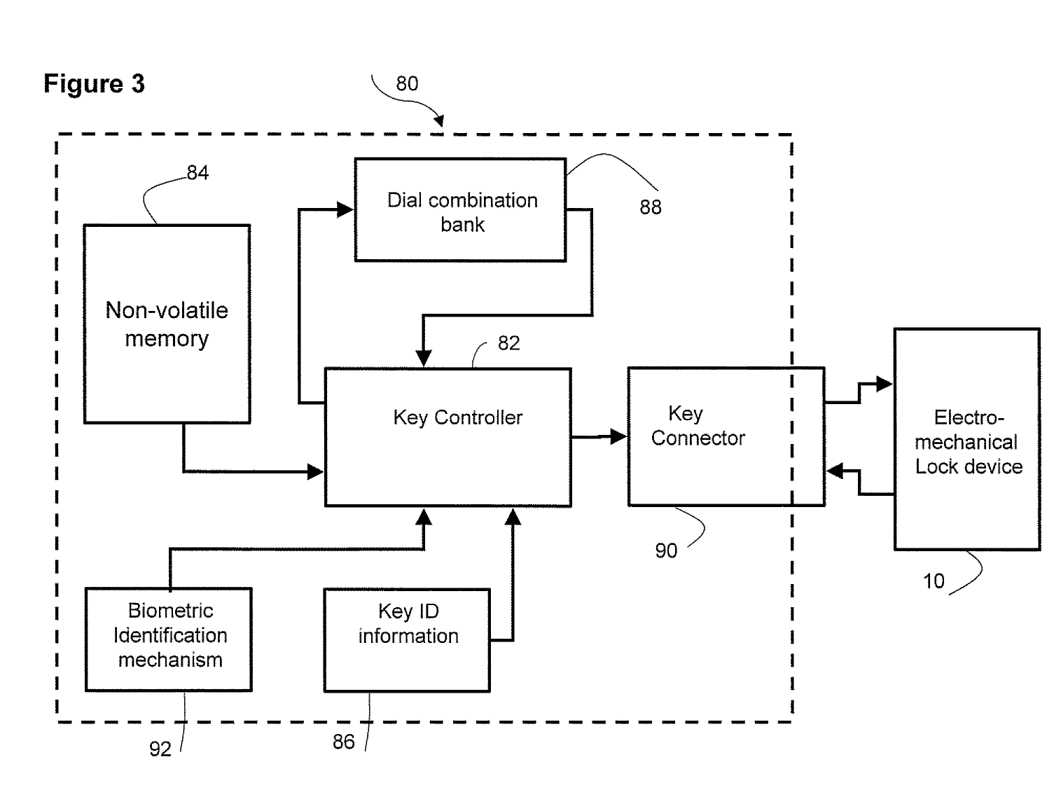

Referring to FIG. 3, there is shown a block diagram of a preferred embodiment of the token 80 of FIG. 1 associated with the electromechanical lock device 10 of the present invention.

A dial combination bank 88 is provided for storing a dial combination of a corresponding electromechanical lock device.

In accordance with a first embodiment of the present invention, identification (ID) information of the user holding the token 80 is stored in a non-volatile storage area of a non-volatile memory 84. The key ID (such as a serial number) is stored in a Key ID unit 86. Upon the establishment of communication between a Key Controller 82 and the electromechanical lock device 10, the ID information and Key ID as well as the dial combination are sent to the Key Controller 82 and then, via key connector 90 (e.g. USB connector, Firewall connector, etc.), sent to the electromechanical lock device 10. The electromechanical lock device 10 then verifies the Key ID and the user's ID information received from the token against data stored in a database 62 and, assuming a match is found, uses the received dial combination to unlock as described herein above.

Clearly, if the dial combination stored in the token is not the dial combination pre-defined to open this specific electromechanical lock device, or the information received from the user's token are not verified by electromechanical lock device, then the electromechanical lock device does not open.

In a second embodiment of the present invention, Key Controller 82 is provided to send the dial combination in two forms—one encrypted with a public key and the other hashed with the key ID. Upon the establishment of communication between token 80 and the electromechanical lock device 10, electromechanical lock device 10 receives the Key ID of the token, the encrypted dial combination and the hashed dial combination. The electromechanical lock device 10 then decrypts the encrypted dial combination (via Lock Decoder 61) using its private key and then hashes (via Hashing unit 73) the decrypted data using the Key ID received from the token.

In case the hashed decrypted data matches the hashed dial combination received from the token, the decrypted data is sent to manipulate motor 34 (via lock encoder 76) to open the lock. If the decrypted data is not the correct dial combination of the electromechanical lock device—then the decrypted data will not open the lock. In such case the token is most likely an authentic token that does not match the electromechanical lock device.

However, in case the hashed decrypted data does not match the hashed version of the encrypted dial combination received from the token, but the encrypted version of the dial combination received from the token is correct—then the decrypted dial combination might open the lock, but in such case a warning signal will be asserted as an indication that the token carries an un-authorized copy of the dial combination. Hashing the dial combination prevents copying “entry rights” from one token to another.

Preferably, the electromechanical lock device of the present invention is implemented to unlock only in association with an authorized token storing the correct dial combination (i.e. such that the hashed decrypted data matches the hashed dial combination received from the token and the decrypted data is the correct dial combination of the electromechanical lock device).

The advantage of such mode of operation is that a hacker who has access to the token and who can retrieve information stored in dial combination bank 88 is not capable of using this information to manually dial the combination and unlock the electromechanical lock device, as the decryption and hashing procedures require possession of the correct key ID. Such a hacker is further not capable of loading the encrypted combination to another token (having a different Key ID) and using this token to open the electromechanical lock device.

In accordance with another embodiment, token 80 includes a biometric means of user identification, such as a fingerprint reader 92, identifying the user holding the token 80 by reading the user's fingerprint. Biometric identification, such as a fingerprint reader, available from IQS Ltd., Israel, adds another dimension of security to the authentication process granting a user an entry right to open the electromechanical lock device.

Optionally, the functionalities of token 80 are embedded within a USB flash memory device, such as a DiskOnKey™, available from msystems Ltd., Kefar Saba Israel. Alternatively, the token operates as a passive RF ID, such that the communication between the token and the electromechanical lock device is wireless. The advantage of a wireless interface is that there is no wear to the connector (such as Key Connector 90) due to the frequent use of the key to open and close electromechanical lock devices.

Programming token 80 with a dial combination according to the identity of a specific user owning the token is provided as optional. For example, a token that is given to a permanent user of high authorization (for example an owner, fire department, police, etc.) can be programmed to instruct controller 46 of electromechanical lock device 10 to bypass the verification process and to manipulate motor 34 according to the transferred dial combination directly. Granting a high-authorized user such a token grants this user immediate access to the electromechanical lock device 10 even if one of the components comprising the electromechanical lock device 10 malfunctions and fails to verify the user.

The advantage of this mode of operation of is that a specific user holding the token will always be able to open the electromechanical lock device, even in if attempt has been made to tamper with the entry right of this user, for example, and deny the user's right to open the electromechanical lock device.

The disadvantage of this mode of operation is that once the dial combination is stored in a token that is given to a user, there is no way to revoke the user's right to enter the electromechanical lock device at any time, apart of mechanically changing the electromechanical lock device. However, such mode of operation is applicable for emergency services, such as fire department or police.

Optionally, electromechanical lock device 10 is configured to inform a remote device on any attempt made (either by an authorized user or an unauthorized user) to operate electromechanical lock device 10.

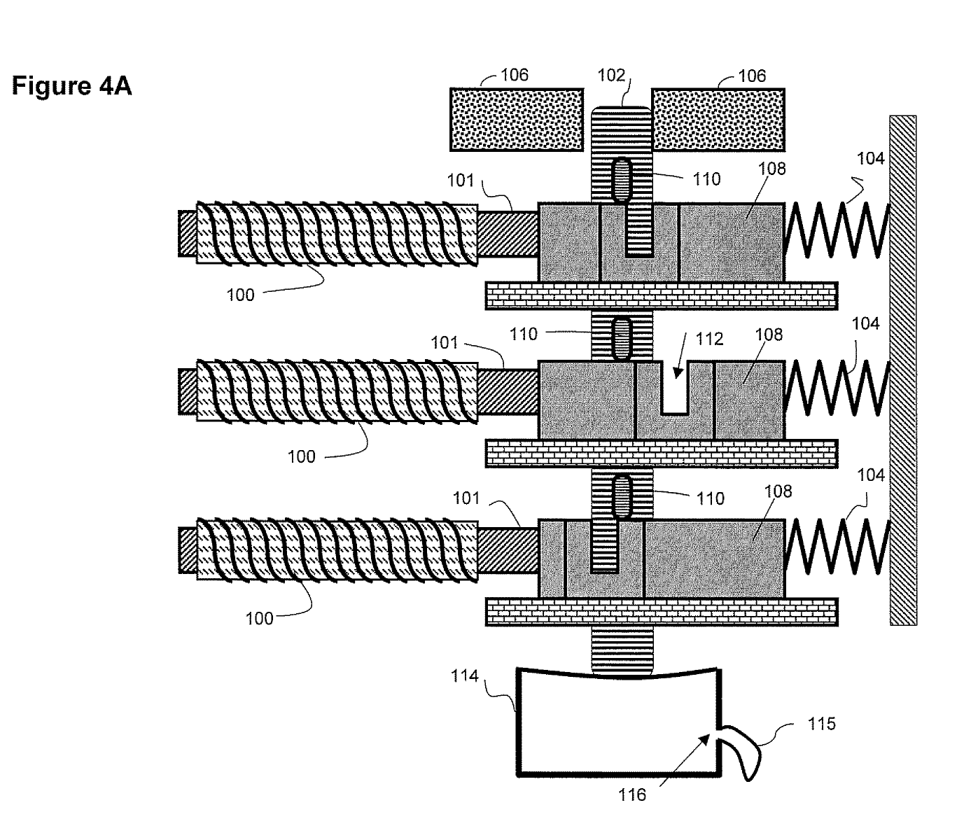

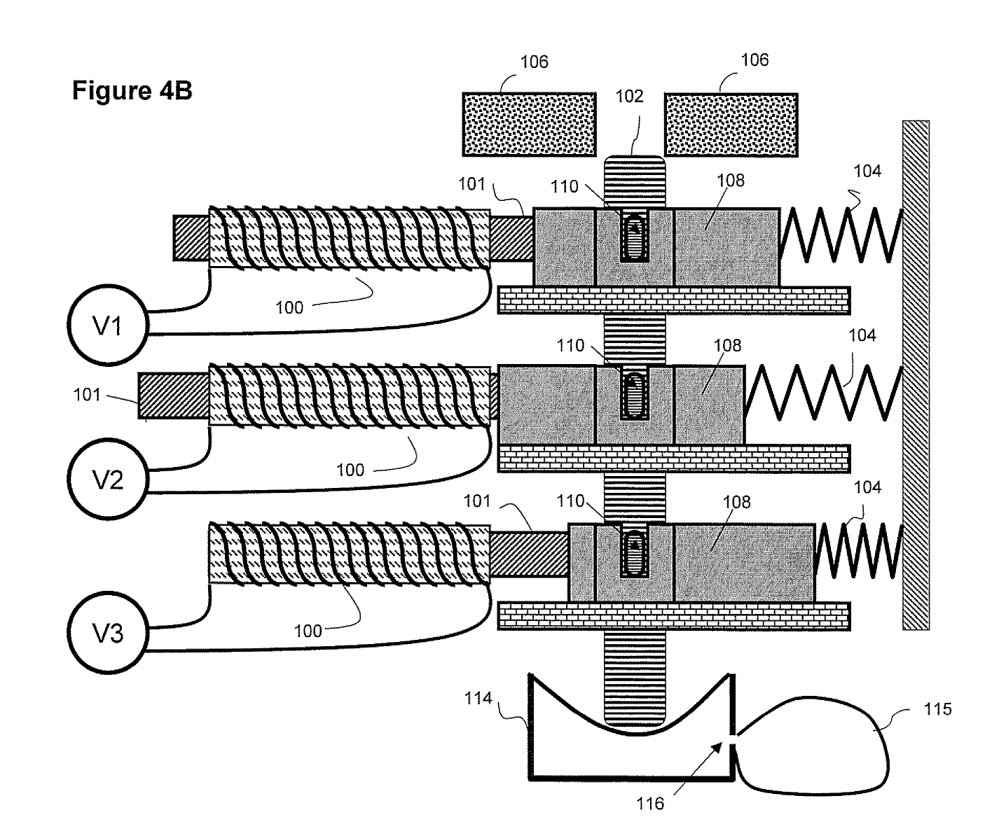

Referring to FIG. 4A, there is shown a schematic illustration of an electromechanical lock device including electromagnetic cores, in accordance with another embodiment of the present invention. Electronic lock device is configured as a combination lock to activate a plurality of electromagnets and unlock according to a pre-determined set of operational instructions, where the pre-determined set of operational instructions are entirely electromagnetic voltage levels.

A locking bar 102, functioning as a hasp, is operationally interlocked to three electromagnetic cores 101 having respective electromagnetic coils 100. Each electromagnetic core 101 includes a latch 108 having a bay 112. Note that locking bar 102 includes three protrusions 110 positioned in association with and configured according to the size of the three bays 112. Three springs 104, attached to the latches 108 of electromagnetic cores 101 respectively, cause electromagnetic core 101 to be in a default position where bays 112 are not coordinated with the protrusions 110 and the locking bar 102 cannot move down and out from its locking state between two bars 106.

A container 114, filled with viscous fluid and covered by a flexible membrane surface is configured with a puncture 116, is positioned underneath and in close relation to locking bar 102. Container 114 is provided to slow down the operational movement of the locking bar 104 when the protrusions 110 of locking bar 104 are accommodated within bays 112 of hasps 108 (see FIG. 4B).

A flexible inflating/deflating means 115 is provided to inflate with the fluid that is slowly streamed out of the container 114 (when the locking bar 102 is pushed down upon the flexible membrane surface and unlocks the electromechanical lock device) and to elastically deflate, thus re-streaming this fluid back into the container 114 (when the pressure is relieved from container 114 as the locking bar is brought back into its locking state). As shown herein in FIG. 4A, the deflation of the fluid from the flexible inflating/deflating means 115 is stopped when the pressures in both the flexible inflating/deflating means 115 and in the container 114 are balanced.

Referring to FIG. 4B, there is shown a schematic illustration of the electromechanical lock device of FIG. 4A, where all three electromagnets are set on the exact voltage levels predefined to open the electromechanical lock device.

The pre-determined set of operational instructions, typically received from a remote source, sets the three electromagnetic coils 100 of electromagnet cores 101 on voltage levels, v1, v2, and v3, respectively. The setting of the voltage levels (which are the exact voltage levels pre-defined to open the electromechanical lock device) cause the electromagnetic cores 101 to be horizontally manipulated athwart the locking bar 102 accordingly, causing the three protrusions 110 of locking bar 102 to properly align above the bays 112 of hasps 108. As a result, the locking bar 102 is gravitationally released from its locking state between the two bars 106 and is pushing down upon the flexible membrane surface of container 114.

This pressure, resulting from the weight of locking bar 102 on the flexible membrane surface of container 114, causes the fluid inside the container to slowly stream out of the container 114 via the puncture 116 and fill the flexible inflating/deflating means 115. This slow deflation is provided to slow down the movement of the locking bar 104, thereby delaying the time until the locking bar 102 is pushed down upon the flexible membrane surface of container 114 and releases the hasps 108 of the electromechanical lock device. The delay in time prevents a hacker from performing a fast voltage-level scanning of random values and provides enhanced security.

Note that as shown in this embodiment, the pre-determined set of operational instructions, which are received as electromagnetic voltage levels, must not necessarily be provided to the electronic lock device in a sequence and can be optionally provided in parallel. The essence of the sequential instructions in a dial-lock is an alternative means to delay a hacker from scanning random values of voltage levels.

It will be understood that the specific physical implementation and form factor of the token of the present invention may be any conventional physical implementation and form factor known in the art: electronic card, optical card, acoustic card, smart card, magnetic card, USB storage device, etc.

Having described the invention with regard to certain specific embodiments thereof, it is to be understood that the description is not meant as a limitation, since further modifications will now suggest themselves to those skilled in the art, and it is intended to cover such modifications as fall within the scope of the appended claims.

1. An electromechanical lock device comprising:
(a) a communication mechanism, operative to receive digital data that include an instruction set of least one operational instruction;
(b) a controller that is operative to produce electronic signals in association with said instruction set;
(c) an actuator that is responsive to said controller to perform a set of operations that correspond to said electronic signals; and
(d) a locking mechanism that is manipulated in response to said set of operations, such that said locking mechanism is operative to unlock according to a pre-defined said set of operations.

2. The electromechanical lock device of claim 1, wherein said actuator includes a motor.

3. The electromechanical lock device of claim 1, wherein said digital data are encrypted.

4. The electromechanical lock device of claim 3 further comprising:
(e) a decrypting mechanism for decrypting said encrypted digital data.

5. The electromechanical lock device of claim 4 further comprising:
(f) a hashing mechanism for hashing said decrypted digital data.

6. The electromechanical lock device of claim 1 further comprising:
(e) an authentication mechanism for authenticating said digital data that are communicated to the electromechanical lock.

7. The electromechanical lock device of claim 6 further comprising:
(f) a memory, wherein a pre-defined instruction set of at least one operational instruction, respective to said pre-defined set of operations, is stored locally.

8. The electromechanical lock device of claim 6, wherein said lock mechanism is operative to unlock conditional on a value of at least one parameter selected from the group consisting of: current time a user operates said lock mechanism, number of recent entries of said user, number of attempts made by said user to open said lock mechanism, content of said digital data, and identity of a token carrying said digital data.

9. The electromechanical lock device of claim 1, wherein said lock mechanism includes at least two movable parts that are reversibly electromechanically manipulated to predefined mechanical positions to unlock said lock mechanism.

10. The electromechanical lock device of claim 1, wherein said communication mechanism includes a mechanism selected from the group consisting of: an electronic sensor, an optical sensor, an acoustic sensor, a magnetic sensor, and a keypad.

11. The electromechanical lock device of claim 1 further comprising:
(e) a token operationally interacting with said communication mechanism to unlock said lock mechanism.

12. The electromechanical lock device of claim 11, wherein said token includes a non-volatile memory, wherein an instruction set of at least one operational instruction pre-defined to unlock said lock mechanism is stored.

13. The electromechanical lock device of claim 11, wherein said token is a portable carrier of information selected from the group consisting of: an electronic card, a smart card, a magnetic card, a key pad, and a USB flash memory data storage device.

14. The electromechanical lock device of claim 11, wherein said token includes a biometric sensor for reading a biological feature of a user.

15. The electromechanical lock device of claim 11, wherein said token operationally interacts with said communication mechanism via a wired communication link.

16. The electromechanical lock device of claim 11, wherein said token operationally interacts with said communication mechanism via a wireless communication link.

17. The electromechanical lock device of claim 1 further comprising:
(e) a manual entry mechanism operative to unlock the electromechanical lock device in response to manually manipulating the electromechanical lock device according to said pre-defined set of operations.

18. The electromechanical lock device of claim 17, wherein said manual entry mechanism includes a dial that is manually manipulated by a user to unlock said lock mechanism.

19. The electromechanical lock device of claim 17, wherein said manual entry mechanism includes a keypad.

20. An electromechanical lock system comprising a plurality of the electromechanical lock devices of claim 1, each said electromechanical lock device operationally interacting with at least one respective token.

21. The electromechanical lock device of claim 1, wherein said controller is further operative to inform a remote device when an attempt is made to operate the electromechanical lock device.

22. The electromechanical lock device of claim 1, wherein said instruction set of at least one operational instruction includes voltage levels of electromagnets.

23. The electromechanical lock device of claim 22, wherein said lock mechanism includes at least two electromagnetic cores that are reversibly electromagnetically manipulated to predefined mechanical positions to unlock said lock mechanism.

24. A method of controlling access to a location, the method comprising the steps of:
(a) receiving digital data that include an instruction set of at least one operational instruction; and
(b) blocking access to the location using an electromechanical lock device that is operative to unlock in accordance with a pre-defined said instruction set of at least one operational instruction.

25. The method of claim 24, wherein said opening of said electromechanical lock device is effected in response to electromechanically manipulating at least two movable parts to pre-defined mechanical positions.

26. The method of claim 24 further comprising the step of:
(c) providing at least one user with a token, storing said pre-defined instruction set of at least one operational instruction, that interacts with said electromechanical lock device to enable access to the location.

27. The method of claim 26 further comprising the step of:
(d) sending, via said token, said pre-defined instruction set of at least one operational instruction to said electromechanical lock device as encrypted digital data.

28. The method of claim 26 further comprising the step of:
(d) sending, via said token, said pre-defined instruction set of at least one operational instruction to said electromechanical lock device as digital data hashed in association with a respective identification parameter of said token.

29. The method of claim 26, wherein said token is a portable carrier of information selected from the group consisting of: an electronic card, a smart card, a magnetic card, a key pad, and a USB Flash memory storage device.

30. The method of claim 26, wherein said interaction of said token with said electromechanical lock device is effected via wired communication.

31. The method of claim 26, wherein said interaction of said token with said electromechanical lock device is effected via wireless communication.

32. The method of claim 24 further comprising the steps of:
(c) storing said pre-defined instruction set of at least one operational instruction locally in said electromechanical lock device; and
(d) authenticating said digital data, such that said electromechanical lock device is operative to unlock contingent on said authentication of said digital data and according to said pre-defined instruction set of at least one operational instruction locally stored in said electromechanical lock device.

33. The method of claim 32, wherein said access to the location is conditional on a value of at least one parameter selected from the group consisting of: current time said user operates said lock mechanism, number of recent entries of said user, number of attempts made by said user to open said lock mechanism, content of said digital data, and identity of said token.

34. The method of claim 24 further comprising the step of manually manipulating said electromechanical lock device, according to said pre-defined instruction set of at least one operational instruction, to enable access to the location.

35. The method of claim 24 further comprising the step of informing a remote device when an attempt is made to operate said electromechanical lock device.

36. The method of claim 24, wherein said pre-defined instruction set of at least one operational instruction include voltage levels of electromagnets.

37. The method of claim 36, wherein said opening of said electromechanical lock device is effected by electromechanically manipulating at least two electromagnetic cores to pre-defined mechanical positions.

38. An electromechanical lock device comprising a lock mechanism that is operative to unlock in response to a pre-defined instruction set of at least one operational instruction remotely communicated to the electromechanical lock device as digital data.

39. The electromechanical lock device of claim 1, wherein said lock mechanism is operative to unlock conditional on recognition of a token that is included in an internal list of authorized tokens.

40. The electromechanical lock device of claim 1, wherein said lock mechanism is operative to unlock contingent on receiving a pre-defined instruction set of operational instructions.

41. The electromechanical lock device of claim 1, wherein said lock mechanism is operative to unlock contingent on receiving an encrypted file that successfully decrypts, using a secret key embedded in the electromechanical lock device, into said instruction set of at least one operational instruction.

42. The electromechanical lock device of claim 41 further comprising:
(e) a mechanism for hashing said decrypted instruction set in association with an identification of a token carrying said encrypted file, such that said lock mechanism is operative to unlock if said hashed instruction set is identical to hashed data pre-loaded on said token.

43. The electromechanical lock device of claim 1, wherein said communication mechanism includes an input device.

44. The electromechanical lock device of claim 1, wherein said lock mechanism is operative to unlock according to all-mechanical input.

45. The method of claim 24, wherein said receiving of said digital data is effected using an input device.

46. The method of claim 24, wherein said receiving of said digital data is effected using, a token.

47. The method of claim 46 further comprising the step of:
(d) encrypting said instruction set on said token.

48. The method of claim 46 further comprising the step of:
(d) storing, on said token, a hashed instruction set that is hashed in associated with an identification parameter of said token.

49. The method of claim 48 further comprising the steps of:
(e) encrypting said instruction set with a secret key of said electromechanical lock device;
(f) decrypting said encrypted instruction set;
(g) hashing said decrypted instruction set in association with said identification parameter of said token; and
(h) conditional on verification of said decrypted instruction set and only if said hashed instruction set is identical to said hashed instruction set stored on said token, unlocking said electromechanical lock device.

50. The method of claim 46 further comprising the step of:
(e) comparing an identification parameter of said token to a list of authorized values stored in said electromechanical lock device.

51. The method of claim 50 further comprising the step of:
(f) remotely editing said list.
